(19) United States
(12) Patent Application Publication
(10) Pub. No.: US 2007/0244983 A1
(43) Pub. Date: Oct. 18, 2007

(54) System and method for delivering content based on demand to a client

(75) Inventor: Adam L. Berger, Pittsburgh, PA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Penthera Technologies Inc., Pittsburgh, PA (US)

(21) Appl. No.: 11/403,151

(22) Filed: Apr. 12, 2006

(51) Int. Cl. G06F 15/16

(52) U.S. Cl. 709/217

(57) ABSTRACT

A content delivering system and method based on demand over a multi-network environment. In one embodiment, the system comprises a server and a client. The server further comprises a content input and a selector unit in communication with the content input, where the selector unit assigns content received from the content input to one of a plurality of categories. In another embodiment, the client is in communication with at least one of a plurality of channels to receive content from the server. In yet another embodiment, the method includes the steps of receiving content at a server, assigning received content to one of a plurality of categories, transmitting the content to the client over at least one of a plurality of channels in response to the category assignment, and receiving the content at the client.

### FIELD OF THE INVENTION

The invention relates to a content delivering system, and specifically to a content delivering system based on demand over a multi-network environment.

### BACKGROUND OF THE INVENTION

A large amount of digital media content is delivered today over the public internet. The content includes live TV and radio channels, pre-recorded video/audio programs, podcasts, movie trailers, and community-generated content. There are many different flavors of products and underlying technology, but they share a common structure: content is stored at a source and is requested by an Internet Protocol (IP)—enabled device, e.g. a PC, PDA, cell phone, set-top box, etc. The content flows from a single origin (one or more physical servers) over the routers, switches, edge caches, and other infrastructures that comprise the public internet, and terminates at a single endpoint; the device which has requested the data. In other words, the data flow is point-to-point (“P2P”) and this way of delivering content is often referred to as unicast. The content may be delivered as a stream intended for immediate viewing or as a file to be stored on the target device for later use.

P2P systems utilize the existing Internet infrastructure via TCP or UDP transport mechanism. When the receiving device is a cellular device, the content may be sent over a 2.5G or 3G cellular network (e.g. GPRS, EDGE, HSDPA) at the user end. Examples of current commercial media delivery services relying on P2P include: CNN's “Pipeline”; Apple iTunes; MTV “Urge”; Verizon's VCAST and MobiTV. In general, the method of content delivery by P2P systems is also called “pull” delivery, since the recipient “pulls” the content from the origin by sending a request for it.

In the past few years, another kind of delivery mechanism for digital content has emerged. Point-to-multipoint (“P2MP”) systems transmit content unidirectionally from a single source to many endpoints. The transmission occurs not through the above-mentioned internet infrastructure, but over proprietary, specialized networks. Similar to the P2P systems, the transmitted content may be streamed in real time or downloaded as a file.

P2MP systems transmit content one-way through a rate-limited channel. The rate is constrained by available spectrum in a broadcast system (e.g. Digital Video Broadcasting—Home (DVB-H)), or by the network capacity in a multicast system (e.g. Multimedia Broadcast/Multicast Service (MBMS)), depending on which system is selected as the channel. In contrast to P2P systems, P2MP systems provide so called “push” delivery, where content is transmitted unidirectionally from an origin point to a set of recipients without any explicit request or acknowledgement by the recipients.

Generally, P2MP systems fall into three categories. The first category is experimental multicast. An example of experimental multicast is Internet2, which is a test bed for research on new networking technologies. The second category is proprietary cellular multicast. This category includes operator-owned 3G networks like Cingular's GSM network. The last category is proprietary broadcast, which includes satellite/terrestrial-based systems such as MediaFLO (www.mediaflo.com) and Modeo (www.modeo.com). Both of these systems are U.S. nationwide broadcast networks that rely on the proprietary radio frequency spectrum. Proprietary broadcast systems use satellite and/or terrestrial transmitters to beam content to a wide population of recipient devices. Such proprietary broadcast systems are infinitely scalable; adding another recipient has no effect on network performance. Typically, a broadcast network aggregates a collection of files and streams into a multiplex which is transmitted through the channel. Inserted into the multiplex is service acquisition information which informs a recipient device of the contents of the multiplex and how to extract each element.

Multicast networks, both experimental and proprietary cellular, are an intermediate step between proprietary broadcast and P2P networks. Multicast networks are built from similar, often identical, network components used in standard P2P networks. In these networks however, the network components are configured to reduce total network load by sharing bandwidth among groups of clients (i.e. endpoints). Each client begins receiving a multicast stream by first passing a request message to an upstream router. The upstream router then may propagate this message to other routers. The message and message-passing is guided by the Internet Group Management Protocol (IGMP). At a high level, routers maintain state on how many endpoints they are serving, and propagate the multicast traffic only when this number is non-zero.

Historically, an early multicast network was MBONE. The MBONE network is a virtual network. It is superimposed over the internet, and enables the flow of multicast IP packets through standard internet, multicast-unaware equipment. More recently, there have emerged some protocols for multicasting over cellular networks. Examples include Multimedia Broadcast/Multicast Service (MBMS), which is intended for GSM (Global System for Mobile Communication)/UMTS (Universal Mobile Telecommunications System) wireless networks and has been standardized in 3GPP release 6 technical specs, and Broadcast and Multicast Services (BCMCS), which is being standardized by 3GPP2. Because multicast solutions are in some sense a compromise between pure unicast and pure broadcast, their scalability properties are also between the two.

An object intended for broadcast/multicast (P2MP) distribution is typically encoded differently from a file intended for unicast (P2P) distribution. In the former case, the encoder processes an object once, irrespective of the number or particular capabilities of the recipient devices. In the latter (unicast) case, the encoder may perform a custom encoding for each recipient device. A second difference is that a broadcast/multicast-encoded stream is formatted differently from the same stream encoded for unicast distribution. That is why different encoders are used for P2P and P2MP systems. In some cases (e.g. Microsoft Windows Media Encoder), an encoder can generate both versions concurrently from a single source file or stream.

Both P2P and P2MP technologies have their respective strengths and weaknesses. P2MP systems are easily scalable in terms of recipients. When a broadcast is delivered through a P2MP system, there is zero marginal cost for adding another end user to the existing receiver pool. However, P2MP networks can only accommodate a fixed bitrate at any time. As a result, owner of the origin point (i.e. the network operator) determines what content is transmitted, when to transmit the content, and in what format to transmit the content. The users at the receiving end have no control over what is being broadcasted.

In contrast, users of P2P systems usually have a much larger selection of media available to them (e.g. Verizon's VCAST online music download service advertises 500,000 available tracks). The breadth of the library is only limited by the storage capacity of the server. In addition, content may be customized in real time as users request it, in the format appropriate for the users' devices. The disadvantages of P2P systems include limited scalability to accommodate large number of recipients. Sending a data object (e.g., a multimedia file) to N recipients requires opening N communications sockets and using N different origin-to-recipient network connections. Consequently, there would be a problem if a large number of users simultaneously request content from the same origin.

Thus, referring to FIG. 1, for a fixed size content object, as the number of clients desiring to access content increases the amount of bandwidth required for a P2P transmission increases and makes the use of a P2MP system more desirable. As the number of clients desiring to access content decreases, P2P systems are better for its distribution.

In addition, today's cellular networks, heavily relied by the P2P systems, often do not have the capacity to deliver streaming high-quality videos and thus limit the end users' experience. Though mobile operators such as Sprint Nextel, Verizon Wireless and Cingular Wireless have spent billions of dollars over the last few years building new 3G wireless networks in order to deliver new video services, their networks are potentially inadequate for delivering high volumes of live TV programming. 3G wireless networks are designed to be “unicast,” which means signals are transmitted between a single sender and a single receiver. If 500,000 people in a city decide to watch the Super Bowl on their cell phones, the network has to transmit a copy of the video to each user, and that may cause serious difficulties to the network system.

The present invention addresses these problems.

### SUMMARY OF THE INVENTION

The invention relates to a content delivering system based on demand over a multi-network environment. Various embodiments of the invention may be implemented by computer software and hardware.

In one aspect, a system for delivering content to a client is provided. In one embodiment, the system comprises a server and a client. The server further comprises a content input and a selector unit in communication with the content input, where the selector unit assigns content received from the content input to one of a plurality of categories. The server also includes a transmission system transmitting the content to the client over at least one of a plurality of channels in response to the category assignment. The client is in communication with at least one of a plurality of channels to receive content from the server.

In another embodiment, the client further comprises an electronic program guide in communication with at lest one of the channels. The electronic program guide may be interacted with through a graphical user interface. In yet another embodiment, the client further comprises a metering access module in communication with at least one channel, wherein the media access module maintains a record of content accessed over the channel. The server may also include a metering access module aggregator in communication with the client metering access module. The server metering access module aggregator reports demand data received from the client to the selector, which then assigns content to one of the categories in response to the demand data. The demand data may be encrypted or devoid of any private user information prior to upload.

In yet another embodiment, the selector unit on the server may assign content to one of the categories in response to past demand data patterns or system administrator input.

In yet another embodiment, the system provides content through a P2P channel, and the client determines upon which channel to receive content. The content may be removed from the P2P channel when demand for the content reaches a predetermined level.

In yet another embodiment, the entry for the content is color coded to indicate content's availability on a channel. A user or an application on the client may decide which channel to access. The client may further comprise an accounting application keeping a record of the number of bytes transferred to the client over each channel. In one embodiment, the user is notified when the number of bytes reaches a predetermined amount.

In various embodiments, content transferred may include on-demand data referring to P2P content. Such content may be audible or visual or consist of a web address pointing to additional content.

In yet another embodiment, the system further includes a messaging application on the client by which a first user can message a second user with information about content.

In another aspect, the invention relates to a method for delivering content to a client. In one embodiment, the method includes the steps of receiving content at a server, assigning received content to one of a plurality of categories, transmitting the content to the client over at least one of a plurality of channels in response to the category assignment, and receiving the content at the client.

In another embodiment, the content received by the client is in response to the periodic demand data sent by the client to the server. In yet another embodiment, the assigning of content to one of the categories is in part in response to past demand patterns based on decision theoretic calculations or feature vectors.

In various embodiments, the method may further comprise the step of maintaining a record of content access over the channel by the client and the channel used to receive the content may be selected by the client.

In a third aspect, a server is provided. In one embodiment, the server comprises a content input, a selector unit in communication with the content input, and a transmission system. The selector unit assigns content received from the content input to one of a plurality of categories. The transmission system transmits the content in response to the category assignment.

In another embodiment, the server further comprises a metering access module aggregator in communication with a client metering access module. The metering access module is also in communication with the selector unit. The selector unit assigns content to one of the categories in part in response to demand data from the metering access module aggregator.

In a forth aspect, a client is provided. In one embodiment, the client comprises a metering access module in communication with at least one of a plurality of channels. The media access module maintains a record of content access over the channel. In various embodiments, a user or an application on the client may decide which channel to access. An application-made selection may be based in part on whether the content is scheduled to be transmitted on a P2MP channel at a future time. The application may also take network costs into consideration in determining which channel to offer to a user.

In another embodiment, the client further includes a timer to set a reminder when the content is transmitted on the P2MP channels.

In yet another embodiment, the client further comprises an accounting application, which keeps a record of the number of bytes transferred to the client over each channel. The accounting application notifies a user once the number of bytes to the client over a channel has reached a predetermined amount.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a diagram illustrating the corresponding relationship between the amount of content delivered and the popularity of the content;

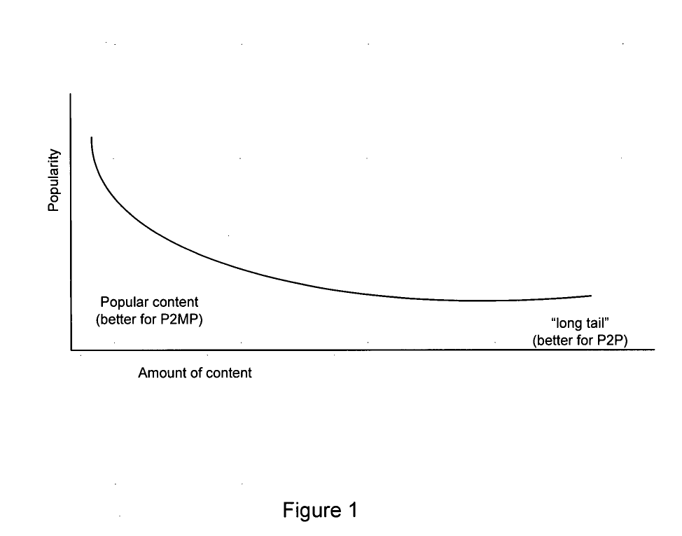

FIG. 2 is a block diagram illustrating the overall system architecture of a content delivering system according to an embodiment of the invention; and

FIG. 3 is a flow chart illustrating a method of delivering content based on demand for the content according to another embodiment of the invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Neither a P2P nor a P2MP system alone addresses all the end-user requirements for media delivery. The present invention describes the design of a hybrid system that combines both types of network technologies in delivering media content. Such a hybrid system can route media objects through one or the other of its constituent networks in a way that puts each network to its best use. A hybrid system disclosed hereby can also use the two existing systems cooperatively in delivering services to end users.

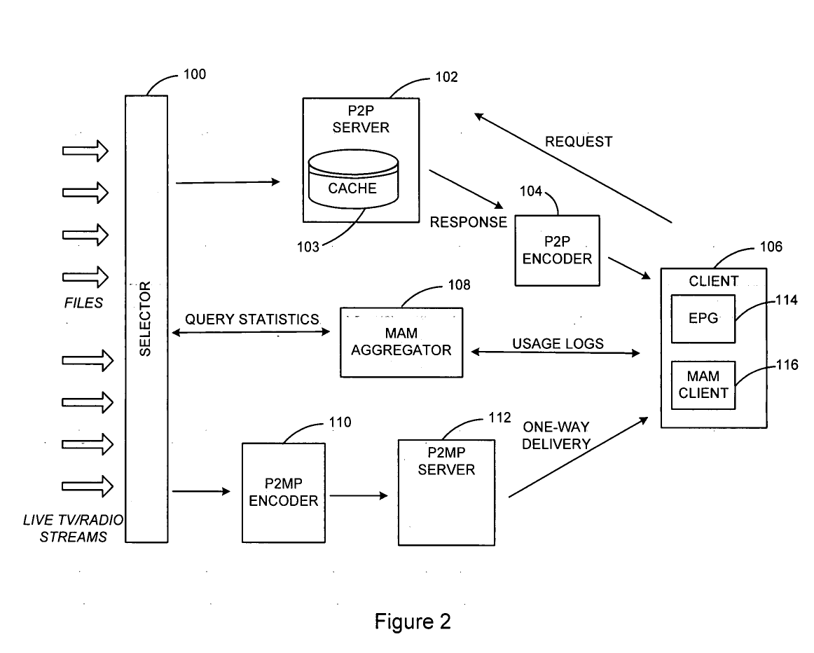

FIG. 2 is a block diagram illustrating the overall system architecture of a content delivering system according to an embodiment of the invention. In this embodiment, data objects (e.g. files and streams) are brought into the system at a network head-end (not illustrated). The input content may have been delivered in many different ways including satellite downlink, IP/Internet, and delivery of physical media. The content is passed through a selector 100, which assigns each content unit (e.g. movie) to one of three categories: 1) unicast only; 2) broadcast only; and 3) both unicast and broadcast. In general, a well programmed selector 100 will assign widely popular content to the second or third category, and less popular content to the first category for transmission through a transmission system. That is, the widely popular content is then forwarded to a P2MP server 112, and the less popular content to a P2P server 102.

According to the embodiment, content delivered to the P2P server 102 resides in a cache 103 for future delivery in response to client requests. Each object residing on the P2P server 102 is assigned a unique acquisition key, e.g. a URL. Upon receiving a request from a client 106, the P2P server 102 transmits the requested content to the client 106 through a P2P encoder 104, which converts the content into a specified format according to the client request. For example, if any of the content corresponds to a stream, that content will be streamed to the client 106 through an open (e.g. UDP socket) connection with the server 102 for this stream. Multiple clients may be requesting and receiving content from the P2P server 102 at the same time, although the figure only displays one client 106 for better illustration.

In contrast, content delivered to the P2MP server 112 has to be encoded by a P2MP encoder 110 prior to reaching the P2MP server 112. The P2MP encoder 110 determines in what format the content will be broadcast, regardless of whether the format is compatible with the software used by the client 106. The formatted content is then buffered and possibly stored on the P2MP server 112 until its scheduled transmission time, when the content is eventually transmitted to the client 106 via a one-way broadcast.

In addition to delivering the data objects themselves to the clients 106, the P2P and P2MP servers 102, 110 respectively also create a Service Listing (not illustrated) containing the objects that are available over each network. This Service Listing may be formatted in many different ways including: as a commonly-used XML schema such as the DVB-CBMS standard; the Nokia OAI specification; a web page, or other open or proprietary specifications.

Each object in a Service Listing contains “acquisition information” which informs the client how to access the object. For example, in the case of an object available over the P2P network, the acquisition information may be a URL. In the case of an object transmitted over the P2MP network, the acquisition information may be one or more of the following: an IP address, a Process ID (PID), a Name Space Constraint (NSC) file, a Session Description Protocol (SDP) file, or a Uniform Resource Name (URN), which is a reference to the object within the multicast stream. The acquisition information for a P2MP object also will contain a start/stop time during which the object will be transmitted.

For efficiency, the P2P Service Listing may simply be a URL pointing to a Service Listing that is available via HTTP from the P2P Server. A similar procedure is not possible for the P2MP network since it cannot be assumed that every P2MP-enabled client can “pull” content, for example, a receiving device with broadcast reception but no unicast capabilities.

Since the P2P and P2MP Service Listings will be delivered separately to the client 106, and the two Listings may contain entries for the same item (e.g. a TV show available on both P2P and P2MP). There is preferably a unique identifier for each object that enables the client 106 to associate the two entries as corresponding to the same program. The identifier can be a unique integer key that is assigned to each object by the Selector 100. The client 106 may take this information into account in a number of ways. For example, the client may display one menu item rather than two and automatically determine, based on current conditions, whether to use the P2P or the P2MP version.

At the client 106, a user (not illustrated) may access a GUI application called Electronic Program Guide (EPG) 114. The EPG 114 includes a menu of available content. A typical list may itemize content: 1) accessible via the P2P network; 2) accessible via the P2MP network; or 3) stored on the local persistent storage device of the client (previously downloaded from either the P2P or P2MP network). Though the P2P and the P2MP networks are distinct, it is at the client 106 that they converge. As a result of this convergence, the EPG application 14 may offer features that integrate the two networks, as discussed in more detail below.

When a user selects one of the entries from the EPG 114, the client 106 accesses the appropriate object. A component on the client 106, the Metering Access Module client (MAM client) 116, keeps track of every object accessed including the amount of data transferred and time of usage. The client 106 uploads the data accumulated by the MAM client 116 to a Metering Access Module aggregator (MAM aggregator) 108. The client 106 may perform this data upload operation when the P2P channel is available, e.g. when the client 106 is receiving updated licenses from a Digital Rights Management (DRM) license-granting entity such as a Windows Media DRM License Server. The MAM aggregator 108 integrates data from all the clients and provides the statistical guidance to the selector 100 on selecting the optimal way of delivering content based on past usage patterns by the clients.

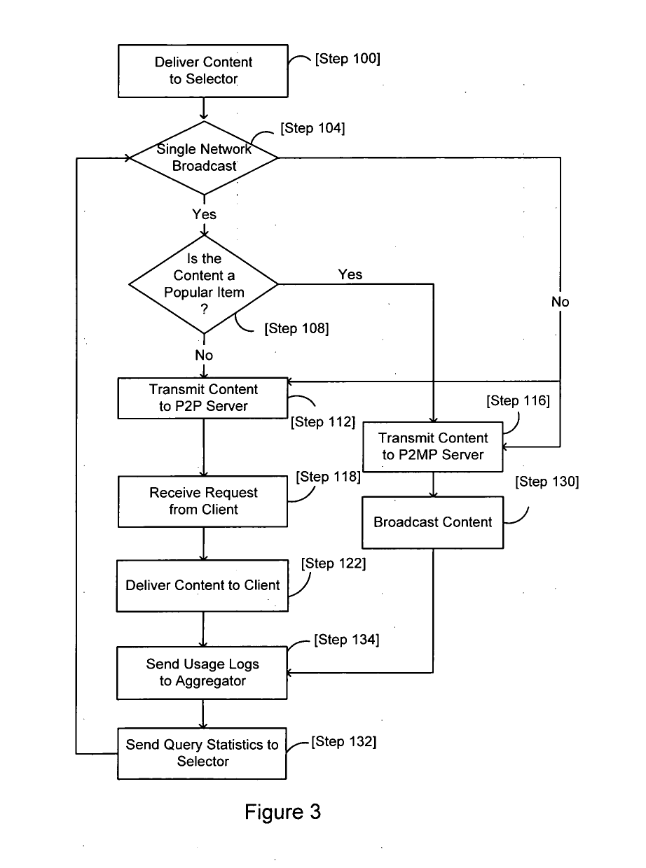

Referring also to the flow diagram of FIG. 3, in operation, the system shown in FIG. 2, performs the following steps. First, content is delivered (Step 100) to the selector (100). The selector 100 determines if the content is to be delivered over multiple channels (Step 104). If it is, the content is delivered to each of the P2P server 102, and P2MP server 112 (Steps 112 and Step 116) respectively. If the selector 100 decides that the content is to be distributed over only one channel, the selector 100 makes a decision over which channel the content is to be transmitted based on some predetermined criterion (Step 108). In this diagram the criterion is based on popularity, but in an actual system any predetermined criterion or even multiple criteria may be used.

If, in this example the content is not popular content, it is transmitted to the P2P server (Step 112), while if the content is popular it is transmitted to the P2MP server (Step 116). Considering the P2P server first, although the content is cached on the server 102, nothing occurs until a request for the content is received from a client (Step 118). Once the request is received, the server 102 delivers the content to the client (Step 122).

Conversely, if the content is popular, the content is transmitted to the P2MP server 112 for subsequent broadcast. In this case, unlike the P2P case, the server decides when and under what conditions to broadcast the content (Step 130). The receiver, receiving the contact on either channel, in one embodiment, keeps a record of the amount of data it receives on each channel and periodically transmits (Step 134) the user records to the MAM aggregator 108. The MAM aggregator 108 then transmits (Step 138) the statistics of the reception of the content to the selector 100. Based at least in part on these statistics the selector 100 can then determine how the content is to be re-broadcast (Step 104).

Considering the principal components in more detail, the selector 100 selects the server(s) over which a particular piece of content is to be transmitted. As previously disclosed, the P2MP server 110 is more efficient when there are many clients seeking to download the content, but it is uneconomical when the content does not have a large enough audience. In the latter case, the P2P server 102 is better suited to handle the delivery by allocating only the amount of bandwidth necessary for transmitting the content to the small number of clients requesting it.

In one embodiment, the selector 100 calculates the costs of delivering content through each servers 102, 110 individually and selects the cheaper channel. The calculation can be done by applying the following formulae:

for P2MP:
cost(P2MP)=size(Content)*MPCBP,
where MPCBP=cost per byte of delivering an object over P2MP network
   for P2P:
   cost(P2P)=N*size(Content)*PCBP
where PCBP=cost per byte of delivering an object over P2P network
N=the number of requests from the clients
   If cost(P2MP) is greater than cost(P2P), the selector 100 sends the object to the P2P server 102, and vice versa. There exists an indifference point N′ where:
   size(Content)*MPCBP=N′*size(Content)*PCBP.
   Since size(Content) factors out, this leaves N′=MPCBP/PCBP. When the number of requests (N) is equal to the number at the indifference point (N′), the costs of sending the content through both servers are the same and thus the selector 100 in one embodiment makes the content available to both servers 102, 112 and allows the client 106 to choose between the delivery method of the content.

To be able to calculate and compare the costs using the aforementioned formulae, it is essential that the selector 100 knows or can accurately estimate, for any specific content, the number of requests received from the clients. In this embodiment, the component that maintains usage statistics for all content and updates the selector 100 with this information is the Metering Aggregation Module (MAM).

The MAM comprises two subcomponents: the MAM client 116 and the MAM aggregator 108. The MAM client 116 resides on each client 106 and writes an entry into the client's persistent storage for every accessed content object, whether accesses via P2MP or P2P. The MAM aggregator 108 collects individual metering data from the clients and consolidates them into a single report. The report is an aggregated table containing a view-count for every content object. The report presents, for every object, the breakdown of how often the object was requested via the P2P and the P2MP servers 102, 112.

According to the embodiment, the MAM client 116 uploads its usage log of recent activity to the MAM aggregator 108 at a time and frequency determined by either the client 106 or the MAM aggregator 108. The uploading process may be done by using HTTP POST. In variations of the embodiment, the data is encrypted before being uploaded and the MAM client 116 removes any information from the log that would uniquely identify the client 106.

For content delivered over the P2MP server 112, the MAM client 116 is essential for capturing usage information since otherwise the system has no way of knowing, for each broadcast, how many clients are accessing the content. For content delivered over the P2P server 102, it is possible to meter requests at the point from where the content is served since the P2P server 102 receives a request from every client for every content object. Alternatively, the system may simply meter all access from either servers 102, 112 on the client 106.

In more detail, the metering process, in accordance with the embodiment, may include additional features. The client 106 may store the metering data in tiny binary format to minimize persistent storage usage. Metering data stores at the client 106 may be uploaded at predetermined intervals. When there are a large number of clients in the broadcast network, it is not efficient for all the clients to report their log activities at the same time. One solution is for each client to use a randomization algorithm such as used in collision avoidance in packet networks to select its upload time. The client 106 may offer a way to force an immediate upload of accumulated metering logs by including it as a menu option on the client. After a successful upload, the client metering log may automatically be deleted to save space. If there are pending events on the client 106 which are older than a certain age, they may be purged automatically every time the client 106 is reset.

Some clients have intermittent connectivity via IR or Bluetooth or sync cable, depending on the availability of these services, rather than permanent connectivity via cellular data channel. For these clients, no available channel is relied on for uploading accumulated metering information because the channel may be disconnected when the service is not available. However, we can count on occasional connectivity, since DRM licenses expire after some period of time and new licenses must be acquired (via Bluetooth, sync, IR, etc.). In the case of these clients, the MAM client 116 will upload the accumulated metering information before acquiring the new DRM licenses.

Based on the query statistics aggregated by the MAM aggregator 108, the selector 100 predicts a value of N(X) for a content object X. Essentially, past usage patterns are used to predict future usage patterns. According to the embodiment, the predictive function applied by the selector 100 takes account the information received in the query statistics such as: frequency of previous distributions of the content; frequency of previous distribution of other shows of the same producer; frequency of previous distribution of other shows of same genre; and frequency of previous distribution of shows with the same actor, etc. In one embodiment, a convex combination (N) of three predictor functions of content object X is:
N(X)=(⅓)*F1(X)+(⅓)*F2(X)+(⅓)*F3(X)
Where
F1(X)=avg. # of times that all other first-run episodes of X was viewed (if X is first-run) or avg. # of times that all other repeat episodes of X was viewed (if X is a repeat)
F2(X)=avg. # of times that all other shows of the same genre (comedy, drama, etc) as X were viewed
F3(X)=avg. # of times that all other shows from the same producer of X were viewed.

In other embodiments, various decision-theoretic approaches (e.g. regression analysis, decision trees) may be employed to fit a parametric predictive function to a collection of historical data.

The system according to the embodiment may also provide an administrator with the ability to manually assign content to a server 102, 112. To facilitate this function, the system may show the administrator a display of all active content objects slated for upcoming distribution along with their predicted popularities. This display may be visual with different colors representing different popularities. The display may also be annotated with suggestions to which network to assign each content object.

In certain embodiments, every content object may always be designated available via P2P. This “guaranteed availability” serves to guarantee access to clients which are incapable of broadcast reception and to provide access to content already broadcast and not slated for any rebroadcast in the near future. The guaranteed availability is sometimes known as the network DVR feature. Supporting the network DVR feature requires a cache 102 in the P2P server 102 to store previously-streamed objects. It also requires that content available over both networks is annotated in the EPG 114 on the client 106. It is up to the client 106 to decide which network to use to acquire the content, with the decision possibly based on factors such as whether the P2MP network is available and whether the content is only broadcast at a certain time over the P2MP network.

According to one embodiment, content may be frequently reassigned between the P2P and the P2MP networks. Occasionally, a content object, especially new content, may be assigned to the P2P network based on a faulty prediction. As mentioned above, the system actively tracks P2P requests for each content object. When the number of requests for a specific object reaches a certain threshold, the system can reassign the object to the P2MP category. Similarly, when content falls below a certain level of popularity, it may be moved to the P2P channel. The decision process governing when to switch category may be based on well-known techniques in machine learning.

Broadcast can often support bitrate over 200 kb/s for broadcast video at Quarter Video Graphics Array (QVGA) resolution, whereas many unicast networks can only support between 40 to 100 kb/s. The frame rate for broadcast is more than 25 frames per second, but that of unicast is often less than 15. Therefore, the content available on the P2MP (broadcast) network is likely higher quality than the one on the P2P (unicast) network. Given that, it is relatively more difficult and expensive to deliver a high-quality media object over a P2P network, the higher quality is also indicated on the interface of the client 106. Based on the quality assessment indicated in the interface, the user can select what quality presentation he or she desires.

When a content object is available on just one of the two networks, the network may be indicated visually through an interface on the client 106 by means such as color-coding. When a content object is available on both networks, the EPG 114 on the client 106 may either display one of the two entries, in which case the client automatically decides which network to use based on a decision process, or display both entries and allow the user to choose. In the former case where a decision is automatically made, the client 106 first checks to see whether the P2MP network is available. If the client 106 is not able to locate a broadcast signal from the P2MP network, it displays only the P2P option. If a broadcast signal is found, the client 106 inquires about the broadcast schedule of the content object on the P2MP network. If the content is not being broadcast at the present time, the client 106 further inquires about the next scheduled time. If the content is available for a later view, the EPG 114 on the client will offer an option in the menu for deferred viewing until the next scheduled time. If his option is selected, the client 106 then sets a reminder for the user and notifies the user aurally or tactilely when the time of broadcast arrives. If there is no future scheduled delivery date for the content, only the P2P option is displayed. If the content is being broadcast at the present time, the EPG 114 offers the options to either view the P2MP version already in progress or the P2P version from the beginning. In other embodiments, additional steps may be included for the client 106 to determine which options to display in its menu.

Frequently there are different owners for each network. A broadcaster may own the P2MP network, whereas an Internet Service Provider (ISP) may own the P2P infrastructure. As a result, the cost of delivering an object over the two networks is incurred to different entities. In some cases, P2P network owner charges its subscribers based on the amount of data transmitted. To be able to accommodate the accounting of having more than one channel owner, the client 106, as disclosed in one embodiment, also tracks information including total bytes delivered from the P2P network and total bytes delivered from the P2MP network. In one embodiment, the client 106 is designed to display an alert when the total amount of P2P network usage for the current billing period is about to reach the data transfer limit. The client 106 may be further configured to disallow P2P usage once a limit has been reached.

In another embodiment, a cooperative P2P (unicast) and P2MP (broadcast) network is disclosed. The P2MP transmission may contain live, streaming radio services. Such live radio services may include, within them, acquisition information which refers to an affiliated on-demand, content object available on a P2P network. For example, the acquisition information may be a URL to an online music download storefront where currently-transmitted track can be downloaded onto the client 106 for future playout. In a similar way, an embedded object inside a radio service may point to an online web service which sells a ring tone associated with the currently-transmitted track. The EPG 114 on the client 106 may present the associated information graphically, e.g. as an icon which the user may select.

The linking of on-demand (P2P-delivered) value-add services to P2MP-delivered services, as disclosed in this embodiment, is not limited to audio services like streaming radio. An embedded object within a commercial for a movie may point to an online web service from which the user may download a trailer for the movie, or the full movie itself.

The client 106 described in the various embodiments above is a laptop computer, a cellular phone, a PDA, or any other mobile devices, wireless or non-wireless. One of the most popular and useful features of such devices is messaging. This embodiment further discloses a method for a user of a first client to inform a user of a second client that a certain content object is available. The EPGs on both clients is designed to include an option to allow the sending and receiving of messages between the clients. The message may be conveyed either as an SMS or email, depending on the capabilities of the devices.

The messages will contain acquisition information about the content object, in either or both of the P2MP and the P2P versions. For example, the message may contain an NSC file to access a multicast version of the content object, and/or a URL to access a unicast (web-served) version only. In other embodiments, the reception of the SMS can automatically trigger the client to access the content object.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A system for delivering content to a client comprising:
a server comprising:
a content input;
a selector unit in communication with the content input, said selector unit assigning content received from said content input to one of a plurality of categories;
a transmission system transmitting said content to said client over at least one of a plurality of channels in response to said category assignment; and
a client in communication with said at least one of a plurality of channels.

2. The system of claim 1 wherein said client further comprises an electronic program guide in communication with said at least one of said plurality of channels.

3. The system of claim 1 wherein said client further comprises a metering access module in communication with said at least one of said plurality of channels, said media access module maintaining a record of content access over said at least one channel.

4. The system of claim 3 wherein said server further comprises a metering access module aggregator in communication with said client metering access module.

5. The system of claim 4 wherein said metering access module aggregator is in communication with said selector unit.

6. The system of claim 5 wherein said selector unit assigns content to one of said plurality of categories in part in response to demand data from metering access module aggregator.

7. The system of claim 5 wherein said client metering access module uploads demand data to said metering access module aggregator periodically.

8. The system of claim 4 wherein said metering access module aggregator in communication with said client metering access module integrates data from a plurality of media access modules.

9. The system of claim 1 wherein said selector assigns a unique identifier to each content.

10. The system of claim 2 wherein said client further comprises a graphical user interface in communication with said electronic program guide.

11. The system of claim 3 wherein said media access module maintaining a record of content access over said channel writes said record into persistent memory of said client.

12. The system of claim 7 wherein said demand data is encrypted prior to upload.

13. The system of claim 7 wherein said demand data is devoid of private user information prior to upload.

14. The system of claim 7 wherein said demand data is uploaded in response to a digital rights management license download.

15. The system of claim 14 wherein the demand data upload is performed prior to the digital rights management license download.

16. The system of claim 1 wherein the selector unit assigns content to one of said plurality of categories in part in response to past demand data patterns.

17. The system of claim 16 wherein the selector unit assigns content to one of said plurality of categories based on decision theoretic calculations.

18. The system of claim 17 wherein the selector unit assigns content to one of said plurality of categories based on feature vectors.

19. The system of claim 1 wherein the selector unit assigns content to one of said plurality of categories in response to system administrator input.

20. The system of claim 1 wherein the content is available through a P2P channel.

21. The system of claim 20 wherein the client determines upon which channel to receive content.

22. The system of claim 20 wherein the content is removed from the P2P channel when demand for the content reaches a predetermined level.

23. The system of claim 20 wherein the server further includes a cache to store previously streamed content.

24. The system of claim 10 wherein an entry for the content is color coded to indicate content's availability on a channel.

25. The system of claim 24 wherein a single entry is indicated for the content when the content is available on more than one channel.

26. The system of claim 25 wherein an application on the client decides which channel to access.

27. The system of claim 25 wherein a user may select which channel to access.

28. The system of claim 26 wherein the application selects which channel to access based in part on whether the content is scheduled to be transmitted on a P2MP channel at a future time.

29. The system of claim 28 wherein the client includes a timer to set a reminder when the content is transmitted on the P2MP channel.

30. The system of claim 28 wherein the application offers to a user a channel to access based in part on minimizing network costs.

31. The system of claim 1 wherein the client further comprises an accounting application keeping a record of the number of bytes transferred to the client over each channel.

32. The system of claim 31 wherein said accounting application notifies a user once the number of bytes transferred to the client over a channel has reached a predetermined amount.

33. The system of claim 1 wherein live content includes on-demand data referring to P2P content.

34. The system of claim 33 wherein the P2P content is a ring tone.

35. The system of claim 33 wherein the on-demand data is presented graphically.

36. The system of claim 1 wherein the content includes embedded data that points to an online web service from which content may be retrieved.

37. The system of claim 1 further including a messaging application on the client by which a first user can message a second user with information about content.

38. The system of claim 37 wherein the information about content includes the availability of the content.

39. The system of claim 38 wherein an execution application on the client to access the content, said execution application being automatically be executed upon receipt of the availability of content.

40. A method for delivering content to a client comprising the steps of:
receiving content at a server;
assigning received content to one of a plurality of categories;
transmitting said content to said client over at least one of a plurality of channels in response to said category assignment; and
receiving the content at said client.

41. The method of claim 40 further comprising the step of maintaining a record of content access over said channel by said client.

42. The method of claim 40 wherein the step of receiving assigned content to one of said plurality of categories is in part in response to demand data received from the client.

43. The method of claim 42 further comprising the step of uploading demand data from said client to said server periodically.

44. The method of claim 40 further including the step of assigning a unique identifier to each content.

45. The method of claim 41 wherein the step of maintaining the record includes the step of writing said record into persistent memory of said client.

46. The method of claim 43 further comprising the step of encrypting said demand data.

47. The method of claim 43 further comprising the step of removing private user information from said demand data.

48. The method of claim 43 whereby said demand data is uploaded in response to a digital rights management license download.

49. The method of claim 48 whereby the demand data upload is performed prior to the digital rights management license download.

50. The method of claim 40 whereby the step of assigning content to one of said plurality of categories is in part in response to past demand patterns.

51. The method of claim 50 whereby the step of assigning of content to one of said plurality of categories is based on decision theoretic calculations.

52. The method of claim 50 whereby the step of assigning of content to one of said plurality of categories is based on feature vectors.

53. The method of claim 40 whereby which channel used to receive the content is selected by the client.

54. The method of claim 40 further comprising the step of removing content from a P2P channel if demand for the content reaches a predetermined level.

55. A server comprising:
a content input;
a selector unit in communication with the content input, said selector unit assigning content received from said content input to one of a plurality of categories; and
a transmission system transmitting said content to said client over at least one of a plurality of channels in response to said category assignment.

56. The server of claim 55 wherein said server further comprises a metering access module aggregator in communication with a client metering access module.

57. The server of claim 56 wherein said metering access module aggregator is in communication with said selector unit.

58. The server of claim 57 wherein said selector unit assigns content to one of said plurality of categories in part in response to demand data from the metering access module aggregator.

59. The server of claim 55 wherein the selector unit assigns content to one of said plurality of categories in part in response to past demand patterns.

60. The server of claim 59 wherein the selector unit assigns content to one of said plurality of categories based on decision theoretic calculations.

61. The server of claim 59 wherein the selector unit assigns content to one of said plurality of categories based on feature vectors.

62. The server of claim 55 wherein the selector unit assigns content to one of said plurality of categories in response to system administrator input.

63. A client comprising:
a metering access module in communication with at least one of a plurality of channels, said media access module maintaining a record of content access over said channel.

64. The client of claim 63 wherein an application on the client decides which channel to access.

65. The client of claim 63 wherein a user may select which channel to access.

66. The client of claim 64 wherein the application selects which channel to access based in part on whether the content is scheduled to be transmitted on a P2MP channel at a future time.

67. The client of claim 63 wherein the client includes a timer to set a reminder when the content is transmitted on the P2MP channel.

68. The client of claim 64 wherein the application offers to a user a channel to access based in part on minimizing network costs.

69. The client of claim 63 wherein the client further comprises an accounting application keeping a record of the number of bytes transferred to the client over each channel.

70. The client of claim 69 wherein said accounting application notifies a user once the number of bytes transferred to the client over a channel has reached a predetermined amount.
